(19) United States
(12) Patent Application Publication
(10) Pub. No.: US 2005/0019528 A1
(43) Pub. Date: Jan. 27, 2005

(54) Method of forming projecting film

(75) Inventors: Tetsuya Yoshitake, Chiba (JP); Toshifumi Tsujino, Hyogo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NIPPON SHEET GLASS CO., LTD., Osaka (JP)

(21) Appl. No.: 10/868,261

(22) Filed: Jun. 14, 2004

Related U.S. Application Data
(63) Continuation-in-part of application No. PCT/JP02/12098, filed on Nov. 20, 2002.

(30) Foreign Application Priority Data
Dec. 14, 2001 (JP) 2001-380896

(51) Int. Cl. B32B 1/00; D06N 7/04

(52) U.S. Cl. 428/141

(57) ABSTRACT

By establishing a projecting part control method that enables the same application liquid to be used for a plurality of different scattering property requirements, there is provided a method of forming a projecting film according to which an increase in the number of times of preparing an application liquid and the frequency of replacing the application liquid can be suppressed, and hence the uptime ratio of coating equipment can be prevented from dropping, and thus the manufacturing cost can be reduced. The method of forming a projecting film comprises a formation step of applying a sol-form application liquid comprising at least one film component and at least two solvents onto a glass substrate 20 to form an applied layer 41, a phase separation step of drying the applied layer 41 to selectively remove at least one of the solvents that acted effectively to homogenize the applied layer 41, thus carrying out phase separation between at least one of the solvents that acts effectively to cause phase separation and at least one of the film components, or between a plurality of the film components, by utilizing a difference in surface tension between at least one of the solvents that acts effectively to cause phase separation and at least one of the film components, or between a plurality of the film components, and a gelation step of removing the solvents to gelate the film components. The drying temperature in the drying of the applied layer 41 is controlled within a range of 200 to 500° C., and the drying time is controlled within a range of 1 minute to 24 hours.

This application is a continuation-in-part application of International Application PCT/JP02/12098 filed Nov. 20, 2002.

### TECHNICAL FILED

The present invention relates to a method of forming a projecting film, and more particularly to a method of forming a projecting film of a light-scattering/reflecting substrate suitable for use in a reflection type liquid crystal display apparatus, a semi-transmission type liquid crystal display apparatus, a projection type display transmitting screen, or the like.

### BACKGROUND ART

In recent years, as display means for mobile display apparatuses and the like, reflection type liquid crystal display apparatuses (hereinafter referred to as “reflection type LCDs”) that use reflected natural light or room light (hereinafter referred to collectively as “external light”) and joint reflection/transmission type LCDs (hereinafter referred to as “semi-transmission type LCDs”) that use reflected external light when the amount of external light is high and use light from a backlight when the amount of external light is low have come to be used from the viewpoint of reducing the electrical power consumption of the display means so that a battery can be made smaller in size.

Out of mobile display apparatuses, images are required to be displayed in full color and with high image quality for mobile telephones and portable computers in particular. For example, reflection type LCDs used in such mobile display apparatuses are required to have a high aperture ratio to increase brightness and to display images with no parallax. An internal scattering/reflecting plate form reflection type LCD described in “FPD Intelligence, February 2000 edition (pages 66 to 69)”, for example, is known as a reflection type LCD that satisfies these requirements.

FIG. 1 is a schematic sectional view showing the structure of a conventional internal scattering/reflecting plate form reflection type LCD.

In FIG. 1, the internal scattering/reflecting plate form reflection type LCD 10 is comprised of a pair of glass substrates 1 and 2 that transmit light, a reflecting film 5, described below, that is formed on an inner surface of the glass substrate 2 and scatters incident light 3 and reflects this light as reflected light 4, color filters 6 that are formed on an inner surface of the glass substrate 1 and transmit only light of a certain wavelength (color), and a liquid crystal layer 7 that is filled between the reflecting film 5 and the color filters 6 and controls the transmission of light.

Of the component parts of the internal scattering/reflecting plate form reflection type LCD 10, the glass substrate 2 and the reflecting film 5 together constitute a light-scattering/reflecting substrate 8.

FIG. 2 is a schematic sectional view showing the structure of the light-scattering/reflecting substrate 8 appearing in FIG. 1.

In FIG. 2, the light-scattering/reflecting substrate 8 is comprised of the glass substrate 2, a projecting film 11 as a light-scattering film that is formed on the glass substrate 2 and has an undulating shape, and a reflecting film 12 that is formed on the light-scattering film 11 and has a shape that follows the undulating shape of the projecting film 11. The reflecting film 12 reflects incident light, scattering the light due to the undulating shape. The projecting film 11 and the reflecting film 12 together constitute the reflecting film 5 described above.

A manufacturing method disclosed in Japanese Patent No. 2698218 is known as an example of a method of manufacturing such a light-scattering/reflecting substrate. As shown in FIG. 3, a light-scattering/reflecting substrate manufactured using this manufacturing method is comprised of a glass substrate 20, a projecting film 21 as an internal scattering layer that is dotted over the glass substrate 20, and a reflecting film 22 that is formed on the glass substrate 20 and the projecting film 21. The manufacturing method is comprised of a step of applying a photosensitive resin, which is an organic material, onto one surface of the glass substrate 20, a step of forming a large number of minute projecting parts by patterning the applied photosensitive resin in a predetermined shape, masking, exposing to light and developing, a step of subjecting the glass substrate 20 on which the projecting parts have been formed to heat treatment to round off angular portions of the projecting parts and thus form the projecting film 21, and a step of forming the reflecting film 22, which is made of an inorganic material such as a metallic material or a dielectric material, on the glass substrate 20 and the projecting film 21 by vapor deposition, sputtering or the like.

However, with this method, there is a problem that the manufacturing process is complicated, and there is a problem that, because the projecting film 21 is made of an organic material, adhesion to the reflecting film 22, which is made of an inorganic material, is poor, and hence the reflecting film 22 easily peels off. Moreover, there is a problem that, when the reflecting film 22 is formed using a vacuum film formation method such as vapor deposition or sputtering, components adsorbed on the surface of the projecting film 21 and unreacted components inside the projecting film 21 are emitted from the projecting film 21 as a gas, thus causing a deterioration in optical properties (reflectance, refractive index, transmitted color tone etc.) of the reflecting film 22.

To resolve such problems, the present inventors invented a projecting film comprised of a film in which a principal skeleton is an inorganic material and side chains are modified with an organic material and a method of forming the projecting film using a sol-gel method, as described in the specification of previously filed Japanese Patent Application No. 2001-170817. As a result, they succeeded in simplifying the manufacturing process, improving adhesion to the reflecting film made of an inorganic material, and preventing deterioration of the optical properties of the reflecting film.

According to the method of forming a projecting film of Japanese Patent Application No. 2001-170817 described above, scattering properties are controlled by controlling the shape of projecting parts; according to this method, the weight per unit area of film component(s) for forming the projecting parts is controlled, i.e. the composition of an application liquid is controlled.

However, the scattering properties required of a light-scattering/reflecting substrate may vary from user to user, and hence it is necessary to control the scattering properties in accordance with these requirements when supplying light-scattering/reflecting substrates.

Consequently, with the manufacturing method described above, when manufacturing light-scattering/reflecting substrates having different scattering property specifications, an application liquid having a different composition must be used every time. Disadvantages thus arise such as the number of times of preparing an application liquid during the manufacturing process increasing, the frequency of replacing the application liquid increasing, and the uptime ratio of coating equipment dropping due to replacement of the application liquid. A new problem of the manufacturing cost increasing thus arises.

It is an object of the present invention to establish a projecting part control method that enables the same application liquid to be used for a plurality of different scattering property requirements, and thus provide a method of forming a projecting film according to which an increase in the number of times of preparing an application liquid and the frequency of replacing the application liquid can be suppressed, and hence the uptime ratio of coating equipment can be prevented from dropping, and thus the manufacturing cost can be reduced.

### DISCLOSURE OF THE INVENTION

To attain the above object, a method of forming a projecting film according to the present invention, which comprises a formation step of applying a sol-form application liquid comprising at least one film component and at least two solvents onto a substrate to form an applied layer, a phase separation step of drying the applied layer while selectively removing at least one of the solvents that acted effectively to homogenize the applied layer, thus carrying out phase separation by utilizing a difference in surface tension between at least one of the solvents that acts effectively to cause phase separation and at least one of the film components, or between a plurality of the film components, and a gelation step of removing the solvents to gelate the film components, is characterized in that the drying temperature in the drying of the applied layer is controlled within a range of 200 to 500° C., preferably 220 to 400° C., more preferably 250 to 350° C., and the drying time is controlled within a range of 1 minute to 24 hours, preferably 2 minutes to 12 hours, more preferably 3 minutes to 1 hour.

In the method of forming a projecting film of the present invention, the film component(s) preferably contain metal compound(s), and preferably at least one of the metal compound(s) is an organically modified metal compound. More preferably, at least one of the metal compound(s) is an alkoxide of a metal selected from the group consisting of silicon, aluminum, titanium, zirconium and tantalum.

In the method of forming a projecting film of the present invention, preferably at least one of the solvents is a single solvent selected from the group consisting of straight-chain glycols having a hydroxyl group at each end thereof represented by the general formula HO—(CH₂)ₙ—OH, where n is 2 to 10, and polyhydric alcohols represented by the general formula HO—(CH₂)ₚ(CHOH)ₘ—OH, where p is 1 to 10 and m is 1 to 2 or a mixed solvent thereof, and preferably having a surface tension of not less than 30 dyn/cm.

In the method of forming a projecting film of the present invention, preferably at least one of the solvents is a single solvent selected from the group consisting of alcohols including methanol, ethanol and propanol, ketones including acetone and acetylacetone, esters including methyl acetate, ethyl acetate and propyl acetate, cellosolves including ethyl cellosolve and butyl cellosolve, and glycols not having a hydroxyl group at each end thereof including propylene glycol and hexylene glycol, or a mixed solvent thereof.

### BRIEF DESCRIPTION OF THE DRAWINGS

FIG. 1 is a schematic sectional view showing the structure of a conventional internal scattering/reflecting plate form reflection type LCD;

FIG. 2 is a schematic sectional view showing the structure of a light-scattering/reflecting substrate 8 appearing in FIG. 1;

FIG. 3 is a schematic sectional view showing the structure of a light-scattering/reflecting substrate manufactured using a conventional manufacturing method;

FIG. 4 is a flowchart of a process for manufacturing a light-scattering/reflecting substrate having a projecting film according to an embodiment of the present invention; and

FIGS. 5A to 5C are sectional views showing a process of forming a projecting film according to the present invention; specifically:

FIG. 5A shows a process of forming an applied layer 41;

FIG. 5B shows a process of forming projecting parts; and

FIG. 5C shows a process of forming a reflecting film 44.

### BEST MODE FOR CARRYING OUT THE INVENTION

A method of manufacturing a light-scattering/reflecting substrate having a projecting film according to an embodiment of the present invention will now be described in detail with reference to the drawings.

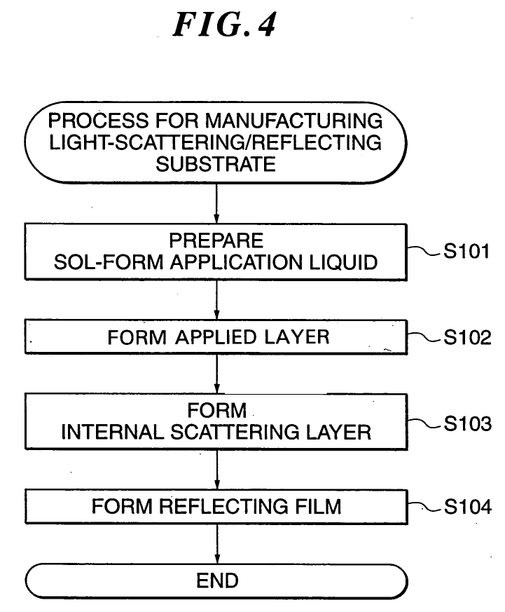

FIG. 4 is a flowchart of a process for manufacturing a light-scattering/reflecting substrate having a projecting film according to an embodiment of the present invention.

The present process is carried out to manufacture a light-scattering/reflecting substrate suitable for use in a reflection type LCD, a semi-transmission type LCD or the like at low cost and to high quality using a sol-gel method, described below.

In general, the sol-gel method is a method in which a solution of organic or inorganic compound(s) of metal(s) is prepared, a hydrolysis/condensation polymerization reaction of the compound(s) in the solution is made to proceed so that the sol solidifies into a gel, and then the gel is heated to produce solid oxide(s).

In the gelation reaction, the metal compound(s) undergo a dehydrating condensation polymerization reaction, and thus the compound(s) is(are) polymerized in which a metal-oxygen-metal network is formed.

If the sol-gel method described above is used, then a projecting film can be formed through only a couple of steps, specifically an applied layer formation step and a drying step, and hence the manufacturing cost can be reduced.

In FIG. 4, a sol-form application liquid in which are mixed film component(s) and solvents is first prepared (step S101).

The film component(s) are made to contain metal compound(s), i.e. inorganic material(s), and hence the adhesion between the film prepared from the film component(s) and a reflecting film made of an inorganic material can be improved, and deterioration of the optical properties of the reflecting film can be prevented.

Alkoxide(s) of metal(s) selected from the group consisting of silicon, aluminum, titanium, zirconium and tantalum are used as the metal compound(s) mixed into the sol-form application liquid. Such metal alkoxides are readily obtainable, are stable at normal temperatures and pressures, and are non-toxic, and thus enable the projecting film as an internal scattering layer manufacturing process to be made simple and hence the manufacturing cost to be reduced. In addition, such metal alkoxides do not absorb light in the visible region, and hence transmitted light is not colored, and thus it is possible to form a projecting film ideal for use in a transmission mode.

Moreover, as at least one of the solvents mixed into the sol-form application liquid, it is effective to use a single solvent selected from the group consisting of straight-chain glycols having a hydroxyl group at each end thereof represented by the general formula HO—(CH₂)ₙ—OH, where n is 2 to 10, and polyhydric alcohols represented by the general formula HO—(CH₂)ₚ(CHOH)ₘ—OH, where p is 2 to 10 and m is 1 to 2, or a mixed solvent thereof, wherein this solvent has a high surface tension (e.g. not less than 30 dyn/cm). It is empirically known that by using such solvent(s), phase separation of a plurality of metal compounds can be carried out efficiently.

Furthermore, as other solvent(s) mixed into the sol-form application liquid, alcohols including methanol, ethanol and propanol, ketones including acetone and acetylacetone, esters including methyl acetate, ethyl acetate and propyl acetate, cellosolves including ethyl cellosolve and butyl cellosolve, glycols not having a hydroxyl group at each end thereof including propylene glycol and hexylene glycol, and so on can be used. Such solvents are able to uniformly dissolve the film component(s) and the other solvent(s), and hence uniform application becomes possible.

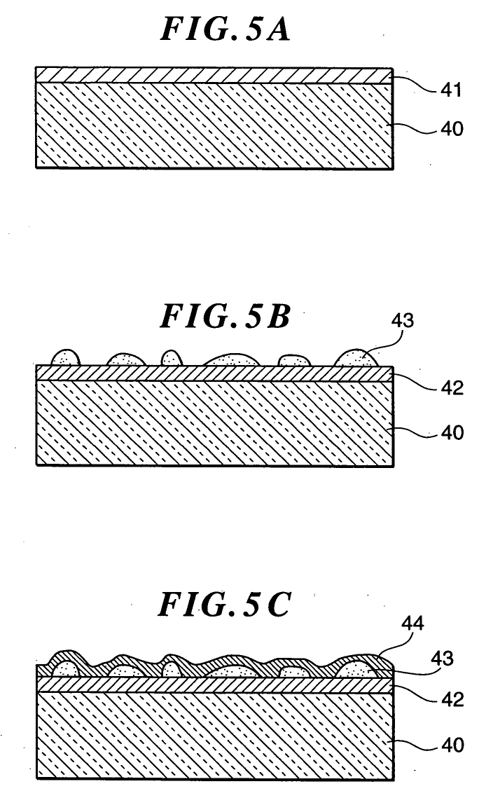

Next, in step S102, the sol-form application liquid prepared in step S101 is applied onto a glass substrate 40, thus forming an applied layer 41 (FIG. 5A).

A known method can be used as the method of applying the sol-form application liquid, for example a method using an apparatus such as a spin coater, a roll coater, a spray coater or a curtain coater, a dip coating method, a flow coating method, or any of various printing methods such as screen printing or gravure printing can be used.

Next, in step S103, the applied layer 41 formed on the glass substrate 40 is dried, thus forming projecting parts.

The drying step can be divided more finely into two steps. One is a step of evaporating solvent(s) contained in the sol-form application liquid; evaporation of the solvent(s) is generally promoted if the temperature is approximately 200° C., although this depends on the boiling point of the solvent (s). Moreover, accompanying this evaporation, phase separation occurs, and the projecting parts are formed at this time.

It is thought that the phase separation occurs as follows, whereby the projecting parts are formed. In the sol-form applied layer, which was originally homogeneous, as evaporation of the solvent(s) that acted effectively to homogenize the applied layer proceeds, insolubilization of film component(s) having a low surface tension to solvent(s) contained in the applied layer having a high surface tension becomes pronounced, and hence phase separation between the two, or phase separation between film component(s) that have a high surface tension and dissolve in the solvent(s) and film component(s) that have a low surface tension, occurs. The applied layer 41 thus separates into two phases, that is a flat phase 42 and a phase 43 in which droplet shapes are maintained, whereby projecting parts are formed (FIG. 5B).

As components of the sol-form application liquid, it is thus effective for formation of the projecting parts to use a single solvent selected from the group consisting of straight-chain glycols having a hydroxyl group at each end thereof represented by the general formula HO—(CH₂)ₙ—OH, where n is 2 to 10, and polyhydric alcohols represented by the general formula HO—(CH₂)ₚ(CHOH)ₘ—OH, where p is 1 to 10 and m is 1 to 2, or a mixed solvent thereof, wherein this solvent has a high surface tension, and film component(s) having a low surface tension.

Examples of such film components having a low surface tension include sol solutions obtained by subjecting organically modified metal alkoxide(s) to hydrolysis or condensation polymerization reaction.

The other step in the drying process is a film densification step, in which condensation polymerization reaction proceeds in the film and hence the film shrinks.

In this densification step, stress is generated inside the film; the thicker the film, the larger the stress becomes, and if the stress becomes too large, then cracks will arise in the film, and hence the adhesion to the substrate will become poor.

It is thus effective to use organically modified metal compound(s) as film component(s) to relax the stress inside the film.

Functional groups known to be effective in relaxing stress inside a film in general include allyl groups, alkyl groups, vinyl groups, glycidyl groups, phenyl groups, methacryloxy groups, mercapto groups and amino groups. Many metal compounds akin to silane compounds are known as metal compounds in which a metal and such an organic functional group are bonded directly together.

The film densification is promoted as the drying temperature is raised, and as a result a strong film can be obtained.

In the projecting film formed through phase separation as described above, when densification proceeds, shrinkage is greater in a direction perpendicular to the glass substrate than in a direction of a plane tangent to the glass substrate, and hence, focussing on the projecting parts, the amount of shrinkage is greater in the height direction of the projecting parts than in the diameter direction of the projecting parts, and hence the aspect ratio (the ratio of the height of the projecting parts to the diameter of the projecting parts) of the projecting parts drops, and thus the angle of slope of the projecting parts drops.

Moreover, in the case of using organically modified metal compound(s) as the film component(s), if the drying temperature exceeds the heat resistant temperature of an organic functional group thereof, then detachment will occur through thermal decomposition, and shrinkage in the height direction of the projecting parts will also be promoted due to the influence of this, and hence the angle of slope of the projecting parts will drop.

On the other hand, it is shown in “Design of undulating reflective plates (MRSs: micro reflective structures) (by Kazuhiko Tsuda, Sharp Corporation; FPD Intelligence, February 2000, p66-70) that the reflected light scattering angle distribution depends on the angle of slope of the projecting parts and the abundance of the projecting parts.

Consequently, by changing the drying temperature, the densification of the projecting film can be controlled, and hence the angle of slope of the projecting parts can be changed, and accompanying this the reflected light scattering angle distribution can be changed. If one wishes to make the reflected light scattering angle distribution narrow, then the drying temperature should be raised so that the angle of slope of the projecting parts will be reduced.

Controlling the drying temperature is thus effective in controlling the reflected light scattering angle, although if the drying temperature is too high, then the shrinkage of the projecting parts will proceed too much, and hence a flat surface will be approached, and thus the projecting film obtained will not be suitable for scattering light. It is thus desirable for the drying temperature to be in a range of 200 to 500° C., preferably 220 to 400° C., more preferably 250 to 350° C.

Moreover, regarding the drying time, the longer the drying time, the more the densification is promoted. The same way of thinking can thus be used as in the case of changing the drying temperature described above; by changing the drying time, the densification of the projecting film can be controlled, and hence the angle of slope of the projecting parts can be changed, and accompanying this the reflected light scattering angle distribution can be changed. If one wishes to make the reflected light scattering angle distribution narrow, then the drying time should be made long so that the angle of slope of the projecting parts will be reduced.

Controlling the drying time is thus effective in controlling the reflected light scattering angle, although if the drying time is long, then productivity will be reduced, which is undesirable. Considering productivity, it is thus desirable for the range within which the drying time is controlled to be 1 minute to 24 hours, preferably 2 minutes to 12 hours, more preferably 3 minutes to 1 hour.

According to the above, even if a sol-form application liquid of a single composition is used, by controlling the drying temperature and the drying time, the angle of slope of the projecting parts can be controlled, and as a result the scattering properties can be controlled.

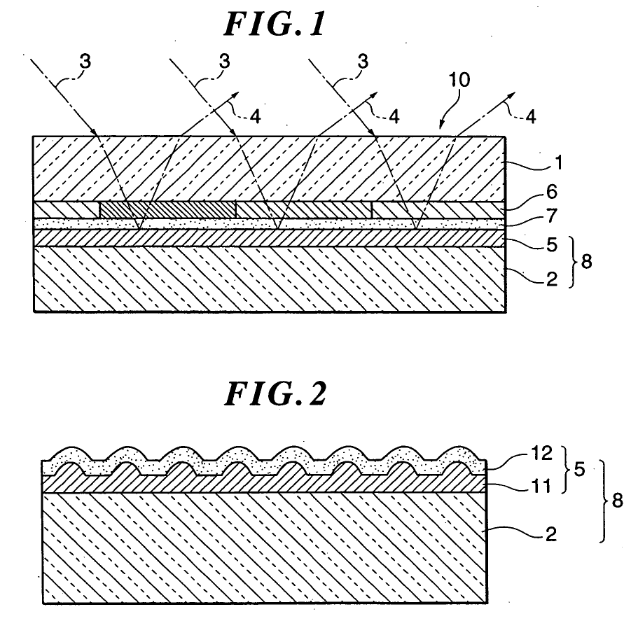

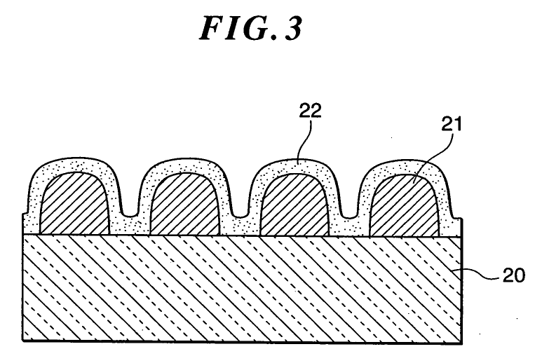

In FIG. 1, in step S104, a reflecting film 44 is formed on the projecting film as an internal scattering layer (FIG. 5C), thus completing the manufacturing process.

The reflecting film 44 is formed to a uniform thickness on the projecting shape of the projecting film, and hence the reflecting film 44 also exhibits a projecting shape.

A thin metal film or a thin film of a dielectric having a reflectance of not less than 50% can be used as the reflecting film 44.

In the case of using a thin metal film as the material of the reflecting film 44, the material is selected from aluminum, silver, and alloys having these metals as a principal component thereof; the thin metal film may be either a single layer, or a plurality of layers made of a plurality of types of metal.

On the other hand, in the case of using a thin film of a dielectric as the material of the reflecting film 44, the reflecting film 44 is formed as a multi-layer film in which are formed a plurality of pairs each comprised of a low-refractive-index layer and a high-refractive-index layer. Silicon oxide or magnesium fluoride is generally used as the material of the low-refractive-index layers, and titanium oxide or tantalum oxide is generally used as the material of the high-refractive-index layers. Such a thin dielectric film does not absorb light, and hence is suitable for use as a semi-transmitting film.

### EXAMPLES

A description will now be given of specific examples of the present invention. Note that the results are collected together in Table 1.

### Example 1

12.5 g of a silica raw material and 3.79 g of a titania raw material as film components, and 6.0 g of glycerol and 27.71 g of ethyl cellosolve as solvents, were mixed together, thus preparing a sol-form application liquid.

The above silica raw material was prepared by mixing together 29.75 g of phenyltrimethoxysilane, 12.42 g of γ-methacryloxypropyltrimethoxysilane and 27.04 g of ethyl cellosolve, and agitating for 24 hours at 20° C. (room temperature), thus bringing about hydrolysis and dehydrating condensation polymerization reaction. At this time, 10.80 g of 1 mol/l (1N) hydrochloric acid was added as a catalyst to promote the hydrolysis.

The above titania raw material was prepared by mixing 28.4 g of tetraisopropoxytitanium with 20.0 g of acetylacetone, thus chelating and hence stabilizing the tetraisopropoxytitanium.

Regarding the composition of the prepared sol-form application liquid, the solid content was 5.0 mass % assuming that the silica raw material and the titania raw material were completely converted to inorganic matter (SiO₂ and TiO₂). The content of the glycerol solvent in the solution was 12 mass %, and representing the SiO₂ content as a mole ratio, the γ-methacryloxypropyltrimethoxysilane to phenyltrimethoxysilane ratio was 1:3, and the silica raw material to titania raw material ratio was 3:1.

Using a 0.55 mm-thick glass substrate manufactured using a float process as a glass substrate, the sol-form application liquid was applied by flexographic printing onto one surface of the glass substrate, thus forming an applied layer.

After that, heating was carried out for 10 minutes at 300° C. in a far infrared furnace, and then natural radiational cooling was allowed to occur down to room temperature, whereby an internal scattering layer was formed on the glass substrate.

A 5000× magnification cross-sectional photograph was taken of the projecting film using a scanning electron microscope (SEM), and the angle of slope of the projecting parts of the projecting film was measured, whereupon the maximum angle of slope was found to be 10°.

Moreover, the surface roughness was measured by carrying out a 500 μm scan of the surface of the projecting film with a stylus at a speed of 50 μm/s using a stylus type roughness meter (Alpha-Step 500 Surface Profiler made by Tencor Instruments), whereupon the maximum surface roughness Rmax was found to be 280 nm. Furthermore, upon observing with optical microscope photography, projecting shapes of diameter approximately 5 to 10 μm were seen on the surface of the projecting film.

The scattered transmitted light angle distribution for the projecting film obtained was measured by illuminating the light-scattering/reflecting substrate with a standard light source D65 using an instantaneous multi-measurement system (MCPD-1000 made by Otsuka Electronics Co., Ltd.), whereupon the angle range was found to be ±15°.

Furthermore, the haze for the projecting film was measured to be 49.0%.

According to the above results, the projecting film obtained in Example 1 exhibited optical properties sufficient for practical use.

Next, a reflecting film having a 3-layer structure, in which silicon oxide of thickness 10 nm, metallic aluminum of thickness 85 nm and silicon oxide of thickness 20 nm were built up in this order by sputtering, was deposited onto the surface of the projecting film obtained, whereby a light-scattering/reflecting substrate was obtained.

For this light-scattering/reflecting substrate, the adhesion at the interface between the projecting film and the reflecting film formed thereon, and the adhesion at the interface between the projecting film and the glass substrate, were evaluated using a cross-cut tape peeling evaluation method (JIS K5400 3.5). The evaluation was carried out through the number of portions for which peeling did not occur out of 100 portions formed by segmenting with cross cuts into an array of 1 mm×1 mm squares, and the result for Example 1 was that peeling did not occur in any of the 100 portions.

Moreover, the reflected light scattering angle distribution for the light-scattering/reflecting substrate was measured using a variable angle glossimeter (UGV-6P made by Suga Shikenki Kabushikigaisha). In the measurement, calibration was carried out such that the specular glossiness for a primary gloss standard plate (black) at an angle of incidence of −45° and an angle of reflection of +45° was 87.2%, and then a 1/10 light-reducing filter (ND filter) was disposed on the light receiver side, light was sent in from −30° onto the light-scattering/reflecting substrate, and the intensity of the scattered light was measured at angles in a range of 0 to 600. The result was that the reflected light scattering angle range was ±20° centered on a measurement angle of 30°, which is the angle of specular reflection.

### Example 2

Using a 0.55 mm-thick glass substrate manufactured using a float process as a glass substrate, the sol-form application liquid used in Example 1 was applied by flexographic printing onto one surface of the glass substrate, thus forming an applied layer.

After that, heating was carried out for 10 minutes at 200° C. in a far infrared furnace, and then natural radiational cooling was allowed to occur down to room temperature, whereby an internal scattering layer was formed on the glass substrate.

A 5000× magnification cross-sectional photograph was taken of the projecting film using a scanning electron microscope (SEM), and the angle of slope of the projecting parts of the projecting film was measured, whereupon the maximum angle of slope was found to be 12°.

Moreover, the surface roughness was measured using the same method as in Example 1, whereupon the maximum surface roughness Rmax was found to be 310 nm. Furthermore, upon observing with optical microscope photography, projecting shapes of diameter approximately 5 to 10 μm were seen on the surface of the projecting film.

The scattered transmitted light angle distribution for the projecting film obtained was measured using the same method as in Example 1, whereupon the angle range was found to be ±20°.

Furthermore, the haze for the projecting film was measured to be 61.9%.

According to the above results, the projecting film obtained in Example 2 exhibited optical properties sufficient for practical use.

Next, a reflecting film having a 3-layer structure, in which silicon oxide of thickness 10 nm, metallic aluminum of thickness 85 nm and silicon oxide of thickness 20 nm were built up in this order by sputtering, was deposited onto the surface of the projecting film obtained, whereby a light-scattering/reflecting substrate was obtained.

For this light-scattering/reflecting substrate, the adhesion at the interface between the projecting film and the reflecting film formed thereon, and the adhesion at the interface between the projecting film and the glass substrate, were evaluated using the same method as in Example 1. The result of the evaluation for Example 2 was that peeling did not occur in any of the 100 portions.

Moreover, the reflected light scattering angle distribution for the light-scattering/reflecting substrate was measured using the same method as in Example 1. The result was that the reflected light scattering angle range was ±30°.

### Example 3

Using a 0.55 mm-thick glass substrate manufactured using a float process as a glass substrate, the sol-form application liquid used in Example 1 was applied by flexographic printing onto one surface of the glass substrate, thus forming an applied layer.

After that, heating was carried out for 1 hour at 300° C. in a far infrared furnace, and then natural radiational cooling was allowed to occur down to room temperature, whereby an internal scattering layer was formed on the glass substrate.

A 5000× magnification cross-sectional photograph was taken of the projecting film using a scanning electron microscope (SEM), and the angle of slope of the projecting parts of the projecting film was measured, whereupon the maximum angle of slope was found to be 8°.

Moreover, the surface roughness was measured using the same method as in Example 1, whereupon the maximum surface roughness Rmax was found to be 230 nm.

Furthermore, upon observing with optical microscope photography, projecting shapes of diameter approximately 5 to 10 μm were seen on the surface of the projecting film.

The scattered transmitted light angle distribution for the projecting film obtained was measured using the same method as in Example 1, whereupon the angle range was found to be ±10°.

Furthermore, the haze for the projecting film was measured to be 36.7%.

According to the above results, the projecting film obtained in Example 3 exhibited optical properties sufficient for practical use.

Next, a reflecting film having a 3-layer structure, in which silicon oxide of thickness 10 nm, metallic aluminum of thickness 85 nm and silicon oxide of thickness 20 nm were built up in this order by sputtering, was deposited onto the surface of the projecting film obtained, whereby a light-scattering/reflecting substrate was obtained.

For this light-scattering/reflecting substrate, the adhesion at the interface between the projecting film and the reflecting film formed thereon, and the adhesion at the interface between the projecting film and the glass substrate, were evaluated using the same method as in Example 1. The result of the evaluation for Example 3 was that peeling did not occur in any of the 100 portions.

Moreover, the reflected light scattering angle distribution for the light-scattering/reflecting substrate was measured using the same method as in Example 1. The result was that the reflected light scattering angle range was ±15°.

TABLE 1

| | | | | Comparative |
|---|---|---|---|---|
| | Example 1 | Example 2 | Example 3 | Example 1 |
| Drying Temperature | 300 | 200 | 300 | 650 |
| (° C.) | | | | |
| Drying Time (min) | 10 | 10 | 60 | 3 |
| Maximum Angle of | 10 | 12 | 8 | 2 |
| Slope (°) | | | | |
| Rmax (nm) | 280 | 310 | 230 | 80 |
| Diameter of Projecting | 5˜10 | 5˜10 | 5˜10 | 5˜10 |
| Parts (μm) | | | | |
| Transmitted Light | ±15 | ±20 | ±10 | ±2 |
| Scattering Angle | | | | |
| Range (°) | | | | |
| Haze (%) | 49.0 | 61.9 | 36.7 | 4.9 |
| No. of Portions where | 0 | 0 | 0 | — |
| Peeling Occurred | | | | |
| (Cross-Cut Tape | | | | |
| Peeling Evaluation | | | | |
| Method) (%) | | | | |
| Reflected Light | ±20 | ±30 | ±15 | Less than ±5 |
| Scattering Angle | | | | |
| Range (°) | | | | |

### Comparative Example 1

Using a 0.55 mm-thick glass substrate manufactured using a float process as a glass substrate, the sol-form application liquid used in Example 1 was applied by flexographic printing onto one surface of the glass substrate, thus forming an applied layer.

After that, heating was carried out for 3 minutes at 650° C. in a muffle furnace, and then natural radiational cooling was allowed to occur down to room temperature, whereby an internal scattering layer was formed on the glass substrate.

A 5000× magnification cross-sectional photograph was taken of the projecting film using a scanning electron microscope (SEM), and the angle of slope of the projecting parts of the projecting film was measured, whereupon the maximum angle of slope was found to be 2°.

Moreover, the surface roughness was measured using the same method as in Example 1, whereupon the maximum surface roughness Rmax was found to be 80 nm. Furthermore, upon observing with optical microscope photography, projecting shapes of diameter approximately 5 to 10 μm were seen on the surface of the projecting film.

Furthermore, the haze for the projecting film was measured to be 4.9%.

The scattered transmitted light angle distribution for the projecting film obtained was measured using the same method as in Example 1, whereupon the angle range was found to be extremely narrow at approximately ±2°, i.e. it was found that light transmitted through the projecting film was hardly scattered at all. Moreover, it was found that the reflected light scattering angle range was also extremely narrow at less than ±5°, i.e. it was found that reflection from the projecting film was mostly specular.

According to the above results, the projecting film obtained in Comparative Example 1 exhibited optical properties insufficient for practical use.

Industrial Applicability

As described in detail above, according to the method of forming a projecting film of the present invention, the drying temperature in the drying of the applied layer is controlled within a range of 200 to 500° C., preferably 220 to 400° C., more preferably 250 to 350° C., and the drying time is controlled within a range of 1 minute to 24 hours, preferably 2 minutes to 12 hours, more preferably 3 minutes to 1 hour, then projecting films having a plurality of different types of scattering properties can be formed from an application liquid of one composition in the method of forming a projecting film by controlling the drying temperature and/or the drying time.

In the method of forming a projecting film according to the present invention, if the film component(s) contain metal compound(s), i.e. inorganic material(s), then in addition to the above effects realized by the present invention, adhesion to a reflecting film made of an inorganic material can be improved.

In the method of forming a projecting film according to the present invention, if at least one of the metal compound(s) is an organically modified metal compound, then in addition to the above effects realized by the present invention, stress inside the film generated in the drying step can be relaxed, and hence cracking of the film can be prevented.

In the method of forming a projecting film according to the present invention, at least one of the metal compound(s) is an alkoxide of a metal selected from the group consisting of silicon, aluminum, titanium, zirconium and tantalum, then in addition to the above effects realized by the present invention, because such metal alkoxides are readily obtainable, are stable at normal temperatures and pressures, and are non-toxic, a projecting film as a light-scattering film manufacturing process can be made simple and hence the manufacturing cost can be reduced, and moreover because such metal alkoxides do not absorb light in the visible region, transmitted light will not be colored, and hence a projecting film ideal for use in a transmission mode can be formed.

In the method of forming a projecting film according to the present invention, at least one of the solvents is a single solvent selected from the group consisting of straight-chain glycols having a hydroxyl group at each end thereof represented by the general formula HO—(CH₂)ₙ—OH, where n is 2 to 10, and polyhydric alcohols represented by the general formula HO—(CH₂)ₚ(CHOH)ₘ—OH, where p is 1 to 10 and m is 1 to 2, or a mixed solvent thereof, and moreover preferably has a surface tension of not less than 30 dyn/cm, and hence in addition to the above effects realized by the present invention, due to using such a single solvent or mixed solvent having a high surface tension, phase separation can be carried out efficiently, thereby forming a projecting film.

In the method of forming a projecting film according to the present invention, at least one of the solvents is a single solvent selected from the group consisting of alcohols including methanol, ethanol and propanol, ketones including acetone and acetylacetone, esters including methyl acetate, ethyl acetate and propyl acetate, cellosolves including ethyl cellosolve and butyl cellosolve, and glycols not having a hydroxyl group at each end thereof including propylene glycol and hexylene glycol, or a mixed solvent thereof, and hence in addition to the above effects realized by the present invention, the sol-form application liquid can be made homogeneous, and hence uniform application becomes possible.

1. A method of forming a projecting film, comprising a formation step of applying a sol-form application liquid comprising at least one film component and at least two solvents onto a substrate to form an applied layer, a phase separation step of drying the applied layer to selectively remove at least one of the solvents that acted effectively to homogenize the applied layer, thus carrying out phase separation between at least one of the solvents that acts effectively to cause phase separation and at least one of the film components, or between a plurality of the film components, by utilizing a difference in surface tension between at least one of the solvents that acts effectively to cause phase separation and at least one of the film components, or between a plurality of the film components, and a gelation step of removing the solvents to gelate the film components,
characterized in that a drying temperature in the drying of the applied layer is controlled within a range of 200 to 500° C., and a drying time is controlled within a range of 1 minute to 24 hours.

2. A method of forming a projecting film as claimed in claim 1, characterized in that the drying temperature is in a range of 220 to 400° C.

3. A method of forming a projecting film as claimed in claim 1, characterized in that the drying temperature is in a range of 250 to 350° C.

4. A method of forming a projecting film as claimed in claim 1, characterized in that the drying time is in a range of 2 minutes to 12 hours.

5. A method of forming a projecting film as claimed in claim 1, characterized in that the drying time is in a range of 3 minutes to 1 hour.

6. A method of forming a projecting film as claimed in claim 1, characterized in that the film components contain at least one metal compound.

7. A method of forming a projecting film as claimed in claim 6, characterized in that at least one of the metal compounds is an organically modified metal compound.

8. A method of forming a projecting film as claimed in claim 6, characterized in that at least one of the metal compounds is an alkoxide of a metal selected from the group consisting of silicon, aluminum, titanium, zirconium and tantalum.

9. A method of forming a projecting film as claimed in claim 1, characterized in that at least one of the solvents is a single solvent selected from the group consisting of straight-chain glycols having a hydroxyl group at each end thereof represented by the general formula HO—(CH₂)ₙ—OH, where n is 2 to 10, and polyhydric alcohols represented by the general formula HO—(CH₂)ₚ(CHOH)ₘ—OH, where p is 1 to 10 and m is 1 to 2, or a mixed solvent thereof.

10. A method of forming a projecting film as claimed in claim 9, characterized in that the single solvent or mixed solvent has a surface tension of not less than 30 dyn/cm.

11. A method of forming a projecting film as claimed in claim 1, characterized in that at least one of the solvents is a single solvent selected from the group consisting of alcohols including methanol, ethanol and propanol, ketones including acetone and acetylacetone, esters including methyl acetate, ethyl acetate and propyl acetate, cellosolves including ethyl cellosolve and butyl cellosolve, and glycols not having a hydroxyl group at each end thereof including propylene glycol and hexylene glycol, or a mixed solvent thereof.
